(19) United States
(12) Patent Application Publication
(10) Pub. No.: US 2007/0110928 A1
(43) Pub. Date: May 17, 2007

(54) Container with a one-piece body

(76) Inventors: David K. Bried, Brentwood, TN (US); Gregory A. Pace, Nunnelly, TN (US); George B. Houk, Murfreesboro, TN (US); Martin Barker, Rochdale (GB)

Correspondence Address: FITCH EVEN TABIN AND FLANNERY, 120 SOUTH LA SALLE STREET, SUITE 1600, CHICAGO, IL, 60603-3406, US

(21) Appl. No.: 11/363,601

(22) Filed: Feb. 28, 2006

Related U.S. Application Data
(60) Provisional application No. 60/657,310, filed on Feb. 28, 2005.

(51) Int. Cl. B31B 1/00; B31B 49/00

(52) U.S. Cl. 428/34.1; 264/299; 493/51

(57) ABSTRACT

A container body, comprising a single fiber structure molded into the container body having an integral bottom portion and an integral side portion; an open cavity defined by the bottom portion and the side portion; and the side portion being perpendicular to the bottom portion such that a rectangular label is mountable to the side portion without creases.

This application claims the benefit of U.S. Provisional Application No. 60/657,310, filed on Feb. 28, 2005.

### FIELD OF THE INVENTION

The invention is directed to a container with a one-piece body, and a method of making thereof; more particularly, a one-piece, molded fiber body having non-drafted sidewalls and a method of making such body.

### BACKGROUND OF THE INVENTION

Fabricating parts, such as bodies of containers, using a molding operation is a cost effective method to mass produce such parts. Injection molding, vacuum forming, and other molding operations are common examples of methods suitable to mass produce typical bodies for containers. When considering such methods, the design of the part as well as the material used are two factors that may affect the fabrication process.

When molding a container, the draft of the container sidewalls often affects the performance of the mold and may limit the design that can be fabricated. Draft is the outward angle or taper of a molded structure or of the corresponding mold cavity or core. That is, draft is the angle between the direction of ejection of a part from the mold and the surface of the mold. For example, cake pans are drafted by being wider at the top than at the bottom. A proper draft angle may be important to facilitate part removal or to prevent sticking of the part to the mold, which may create drag marks during part ejection. For this reason, molded containers usually have drafted or tapered side portions. Such design limitation is often a shortcoming that restricts the design or shape that can be fabricated by molding.

A non-drafted, one-piece container, such as one having side walls perpendicular to a bottom wall, are desired for many reasons. The traditional, drafted container, such as one with a wider top than bottom, often creates difficulty with the application of a label to an outside side wall of the container. A square or rectangular shaped label, for example, usually cannot be applied to the sidewall of a drafted container cleanly or easily. Such combination (i.e., drafted container and rectangular label) may result in a label with wrinkles, creases, or bends that creates an unpleasing appearance. To achieve a flat label, the drafted container usually requires a conic-shaped label that is often difficult to apply in a correct orientation; therefore, creating a skewed label that also presents an unpleasing appearance.

Non-drafted containers are usually difficult to mold; therefore, other factors, such as material characteristics, may also be considered to impart more flexibility into the molding process. In some cases, optimizing the mold design with the material to be molded allows fabrication of parts with less or no draft. However, such improvements are usually only limited to specific materials. For example, cellulose container one-piece bodies with non-drafted sides have previously been difficult to achieve because of the traditional limitations due to mold design.

In some instances, however, cellulose bodies for containers are desired because of consumer preference, easy of handling, or improved material storage. It is similarly desired to fabricate cellulose bodies for containers with non-drafted walls for ease of label application. Because the molding of non-drafted cellulose bodies for containers has previously been difficult, prior attempts to fabricate such non-drafted bodies for cellulose containers have focused on bonding multiple components. For instance, bonding two or more separate cellulose parts with a suitable glue, adhesive, or other fixative is a common method to form a non-drafted cellulose body for a container. A flat circular bottom wall, for example, can be glued to an annular sidewall to form a body for a container having non-drafted walls. However, even this configuration has several shortcomings. Such multiple component structures lack strength and the bond may separate causing container body failure.

It is common, for example, that the bond between the structures may weaken or even separate upon contacting moisture. In addition, the separate components are often laminated fiberboard sheets that can delaminate upon contacting moisture. Moreover, fabrication of such multiple-component bodies for containers is costly and complicated requiring multiple parts, adhesives, alignment issues, and additional process steps.

There is therefore a need for a new one-piece, molded fiber container body having non-drafted sidewalls, and an economical and ecological method of making such container body.

### SUMMARY OF THE INVENTION

One aspect of the invention is a container body that includes a single fiber structure molded into the container body having an integral bottom portion and an integral side portion; an open cavity defined by the bottom portion and the side portion; and the side portion being perpendicular to the bottom portion. That is, the angle between the side portion and the bottom portion is about 90±2°. In other words, the side portion has a draft angle of between about 0° and 2°. With such configuration, a rectangular label may be mountable to the side portion without creases.

Another aspect of the invention is a method of forming such containers. The method includes the steps of (1) drawing fibers into a first-cavity mold; (2) forming the fibers into an initial body shape within the first-cavity mold; (3) transferring the initial body shape to at least one further cavity mold; and (4) forming the initial body shape into the container body within the at least one further cavity mold. In this method, the first-cavity mold preferably has a draft of about 1.5° or less. The at least one further-cavity mold may have a draft less than or equal to the draft of the first-cavity mold and, preferably, has a draft of about 0°. In another aspect of the method, the first-cavity mold and the at least one further-cavity mold may include a porous liner, which may be a weld-free screen.

A “container” means within this disclosure a “closed container including a container body or body and a container lid or lid”. “Body” and “lid” may contain the same or different material.

### BRIEF DESCRIPTION OF THE DRAWINGS

FIG. 1 depicts a side elevational view of an exemplary fiber container body illustrated without a lid;

FIG. 2 depicts a top plan view of the body of FIG. 1 without a lid;

FIG. 3 depicts a bottom perspective view of the body of FIG. 1;

FIG. 4 depicts a perspective view of the body of FIG. 1 shown with the lid on the body;

FIG. 5 depicts an exploded perspective view of the container body of FIG. 1 illustrated with the lid connected to the body by ghost lines;

FIG. 6 depicts a cross-sectional view of the body of FIG. 1 and separate lid connected to the body by ghost lines;

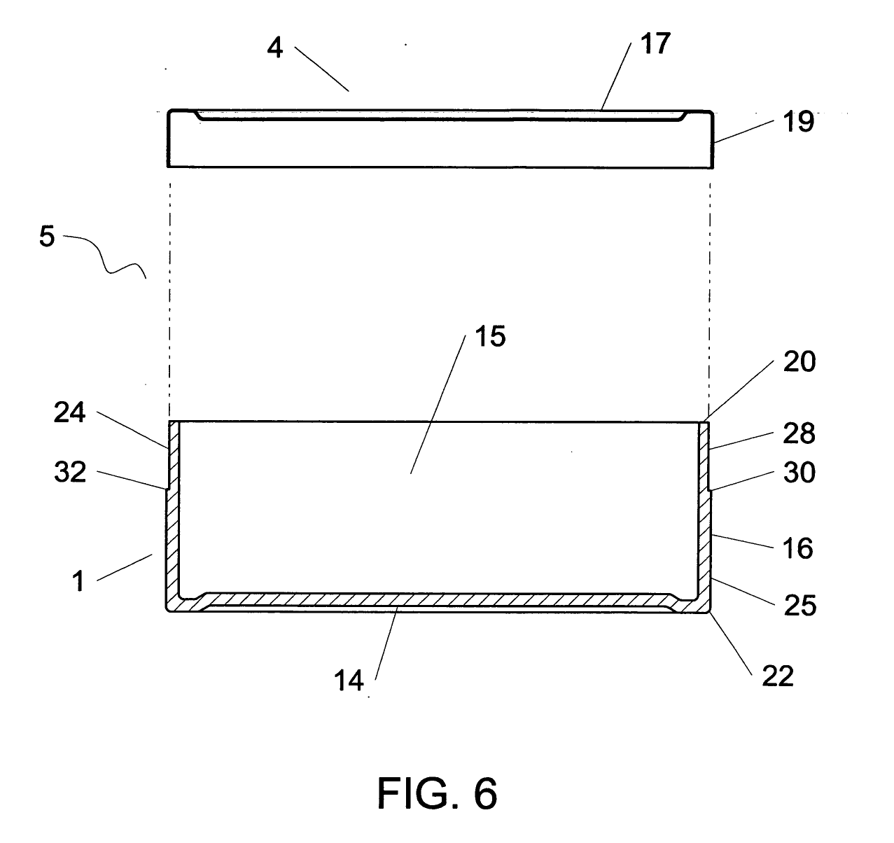

FIG. 7 depicts a cross-sectional view of the body of FIG. 1 and separate lid connected to the body by ghost lines after the optional coating of the inside walls of the body with a wax;

FIG. 8 depicts a cross-sectional view of the body of FIG. 1 with a lid connected to the body after the optional coating of the inside walls of the body with a wax and the optional application of a label on the horizontal outside walls of the body and the lid;

FIG. 9 depicts a detailed cross-sectional view of the container body and lid as generally indicated in FIG. 8; and

FIG. 10 depicts a schematic view of a container body trimming and lid recess forming operation.

### DETAILED DESCRIPTION OF THE PREFERRED EMBODIMENT

There is provided a non-drafted, fiber container body that is formed from a single fiber structure and has an integral bottom portion and an integral side portion. The portions define an open cavity. The side portion is non-drafted by being perpendicular to the bottom portion. That is, the angle between the side portion and the bottom portion is about 90°±2°. In this configuration, the container may receive a rectangular shaped label that may be mounted to the side portion without creases, wrinkles, folds, or the like. It is preferred that the container is formed from pulp fibers and has a cylindrical shape.

In the embodiment, the side portion, which may be flat, may be tapered, outwardly from a perpendicular configuration with the bottom portion between about 0° and about 2°±1°. Preferably, the side portion is tapered outwardly from perpendicular about 0°±1°. In one embodiment, the body is about 0.068 to about 0.055 inches thick; however, other thicknesses are possible depending on container design and intended use.

In another embodiment, the side portion may be divided into multiple portions. For example, the side portion may further include a body portion or lower side portion extending upwardly from the bottom portion, a neck portion or upper side portion recessed inwardly from the body portion, and a shoulder portion interposed between and joining the body portion to the neck portion. The neck portion is for receiving a lid. For example, the container may further include a lid that has a top wall and a side wall. Generally, the lid side wall may slide over the neck portion such that an outside surface of the lid side wall is flush with an outside surface of the body portion. Preferably, if used, the neck portion is recessed between about 0.03 and about 0.01 inches.

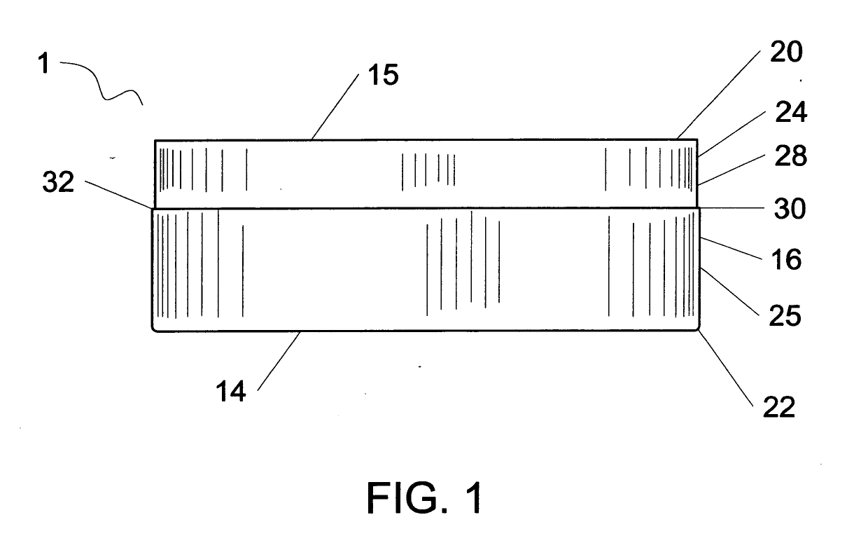

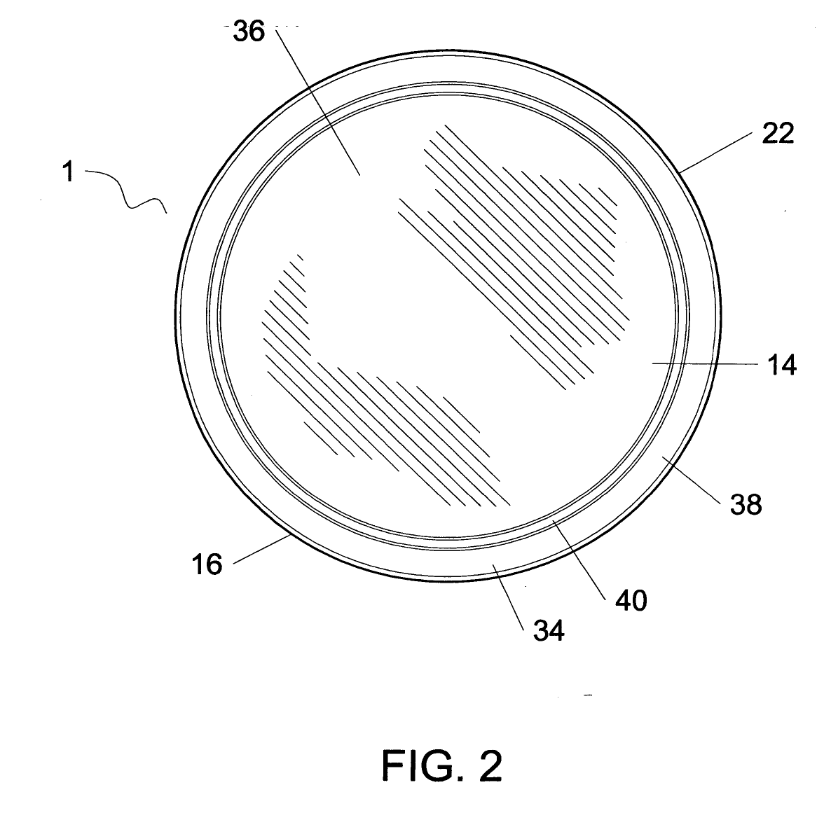

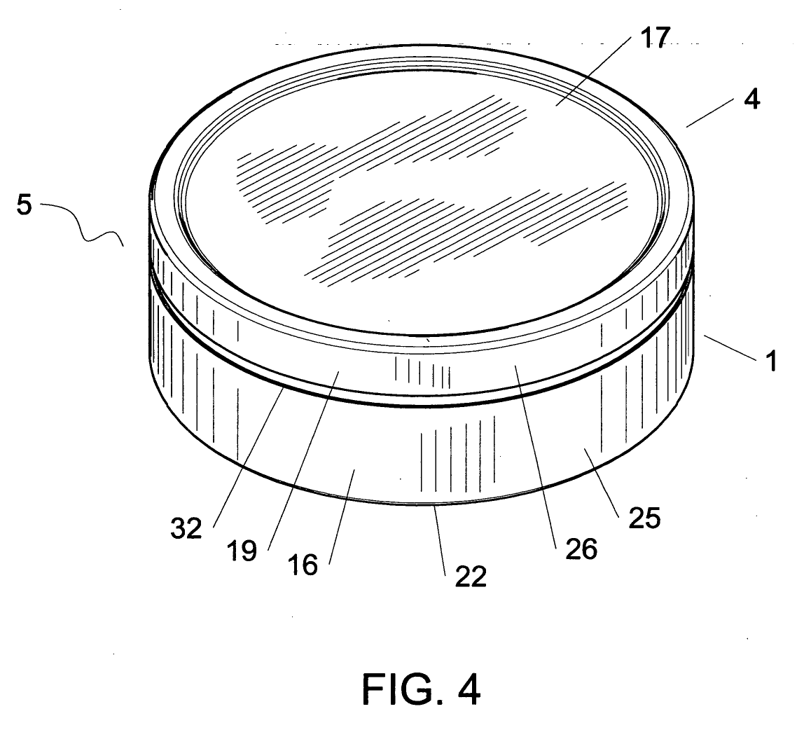

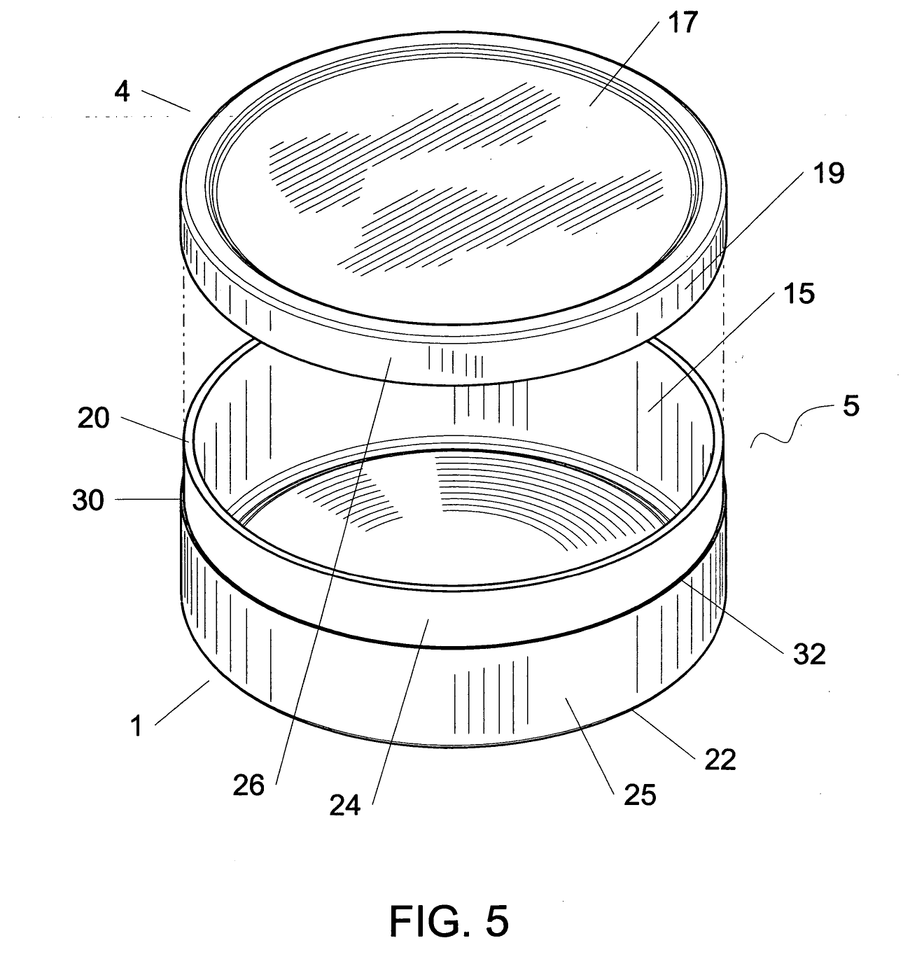

Referring to FIGS. 1 to 5, there is illustrated a container 5 that includes a fiber container body 1 embodying features of the present invention. In general, body 1 includes a single structure formed from fibers that has both a bottom portion 14 and a side portion 16 that combine to define an open cavity 15. An upper edge 20 of the side portion 16 defines an open mouth of the cavity 15. Preferably, the body 1 has a non-drafted side portion 16; that is, the side portion 16 is perpendicular to the bottom portion 14. In other words, the angle between the side portion 16 and the bottom portion 14 is about 90°±2°. The container 5 includes the body 1, and optionally, includes a lid 4, which is receivable by sliding over an upper edge 20 of the side portion 16 within a lid recess or sleeve 24. The lid 4, which may be a metal or a metal alloy, preferably contains tin, aluminum, or the like. The lid 4 includes a top wall 17 and a side wall 19. The lid 4 can be any common lid 4 known in the art.

More specifically, the body 1 is preferably a single structure that is formed or molded into the desired shape from cellulose, pulp, pulp fibers, or the like. That is, the bottom portion 14 and the side portion 16 are integrally formed into the single structure, preferably in a molding operation or other suitable forming operation. The bottom portion 14 and the side portion 16 form a single piece body to define the cavity 15. In a more preferred embodiment, body 1 forms an right circular cylinder having an open top, where the bottom portion 14 has a circular or disk shape forming the base or bottom wall of the cylinder and the side portion 16 is an integral, annular wall forming the side of the cylinder.

Preferably, the side portion 16 is non-drafted. That is, the side portion 16 is perpendicular to the bottom portion 14. While such orientation is preferred, for purposes of this description, non-drafted also means that the side portion 16 may also have a slight outward taper. For example, the side portion 16 may taper outwardly away from a perpendicular orientation with the bottom portion 14 from about 2° to about 0°. In other words, the angle between the bottom portion 16 and the side portion 14 may be between 90° and 92°. However, it is most preferred that the side portion 16 taper outwardly from perpendicular about 0°±1° or, in other words, it is most preferred that the side portion 16 forms an angle with the bottom portion 14 of about 90°.

The side portion 16 defines a side boundary of the cavity 15. That is, the side portion 16 extends upwardly a predetermined height from an edge 22 of the bottom portion 14 and terminates in the upper edge 20. Preferably, the side portion 16 is also the annular wall of the cylindrical body 1. The side portion 16 is preferably from about 0.068 to about 0.055 inches thick; however, such thickness may vary. The side portion may comprise a single portion or have multiple portions with varying thicknesses as previously mentioned. Preferably, the side portion 16 is about ¾ inches high; however, other heights are appropriate depending on the container desired or the intended use.

As shown in FIG. 1, the side portion 16 preferably includes multiple sections, such as the lid recess or sleeve 24 and a body portion 25. If divided into multiple portions, the lid recess 24 is the upper section of the side portion 16 and the body portion 25 is the lower section of the side portion 16. The body portion 25 is flat and extends upwardly from the bottom edge 22 and joins with the lid recess 24, as is more fully described below.

The lid recess 24 allows body 1 to receive the lid 4. Preferably, the lid recess 24 is recessed a sufficient distance so that an outside surface 26 of the lid side wall 19 is flush with an outside surface of the body portion 25 when the lid 4 is received on the container body 1. The lid recess 24 allows the outside diameter of a received lid 4 to be flush with the outside diameter of the container body portion 25.

The lid recess 24 may be formed by compressing, trimming, filing, or shaving the top section of the side portion 16 to form the recess 24. Preferably, the lid recess 24 is recessed between about 0.030 and about 0.010 inches and, most preferably, about 0.010 inches. After formation, the lid recess 24 includes a neck portion 28 that extends downwardly from the upper edge 20, an outwardly extending landing portion 30, and a shoulder portion 32 that transitions the landing portion 30 to the body portion 25.

In alternative embodiment, the container body 1 may have a side portion 16 with only one section. In such alternative embodiment, the container body 1 would not have the lid recess 24. In this form of the container body 1, any lid 4 used with container body 1 would not be flush with the side portion 16 and the outside diameter of the container body 1 would be slightly less than the inside diameter of the lid 4 in order for the container body 1 to accept the lid 4.

Referring to FIGS. 1-3, the bottom portion 14 defines a bottom surface of the cavity 15. That is, the bottom portion 14 extends between opposing surfaces of the side portion 16. The bottom portion 14, in one embodiment, is between about 0.068 to about 0.055 inches thick; however, other thicknesses are possible depending on the container or intended use. The bottom portion 14 may be a circular base or disk that, in a preferred embodiment, is about 2.5 inches in diameter; however, other sizes are suitable depending on the desired container body 1 or intended use.

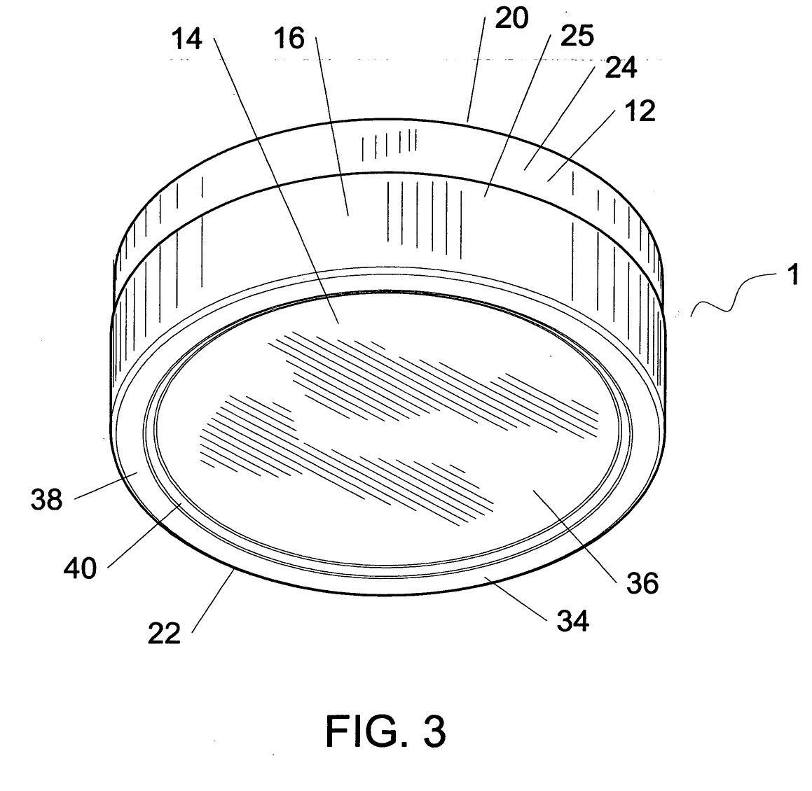

As best shown in FIG. 3, the bottom portion 14 preferably includes a strengthening portion 34 and a recessed base portion 36. The strengthening portion 34 imparts structural stiffness to the container body 10. To provide stiffness, the strengthening portion 34 may include multiple sections. For example, the strengthening portion 34 may include a band portion 38 and a connecting portion 40. The band portion 38 extends inwardly along the general plane of the bottom portion 14 from the bottom edge 22 to form a flat annular band around the periphery of the bottom portion 14. The connection portion 40 is a second annular band that tapers inwardly to the cavity 15 and joins the band portion 38 to the recessed base portion 36. As a result, in this configuration, the base portion 36 is recessed inwardly from the band portion 38. While the strengthening portion 34 is illustrated as an exemplary structure to improve the container body 1 stiffness, other common strengthening structures known in the art may also be used in the design of the container body 1.

Container body 1 is formed from fibers, preferably from compressed cellulose, pulp, cardboard, pulp fiber or a mixture thereof that can be formed into the desired shape, such as the container body 1, and has a predetermined moisture level and thickness. In addition, the container body 1 may also include corrugate, brown paper, clipboard, recycling paper, copy paper, printer paper, polymer fibers, or cotton fibers. The fibers are preferably blends of 40-60 weight-% long cardboard fibers and 40-60 weight-% short cardboard fibers, which are compressed in a molding operation to the desired container body shape, as will be more fully described below. Optionally, the fibers may further include a blend of binders, emulsifiers, water proofing agents, or other suitable components known in the art for use with cellulose structures.

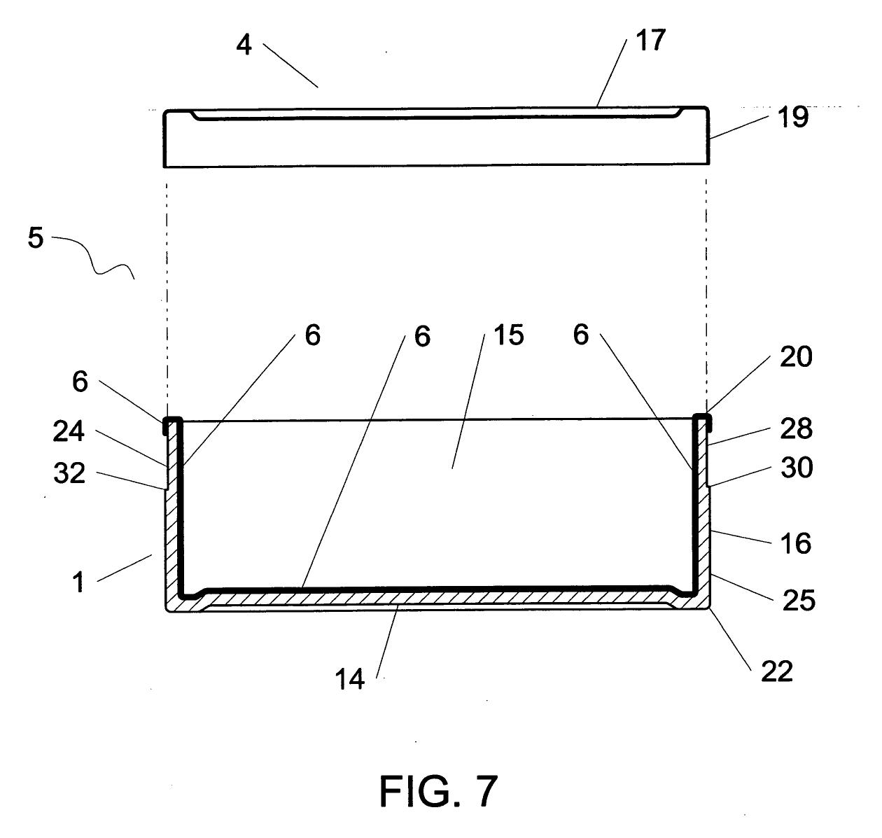

Referring now to FIGS. 7-9, optional features of the container 5 will now be discussed. For example, the container body 1 may include a wax coating 6 and/or a label 7. Referring to FIG. 7, if included on the container body 1, the wax coating 6 is preferably coated on an inside surface of the bottom wall 14 and an inside surface of the side wall 16. As best shown in FIG. 7, if the wax coating is applied to the container body 1, it may also be wrapped around the top edge 20 and slightly down an outside surface of the lid recess 24.

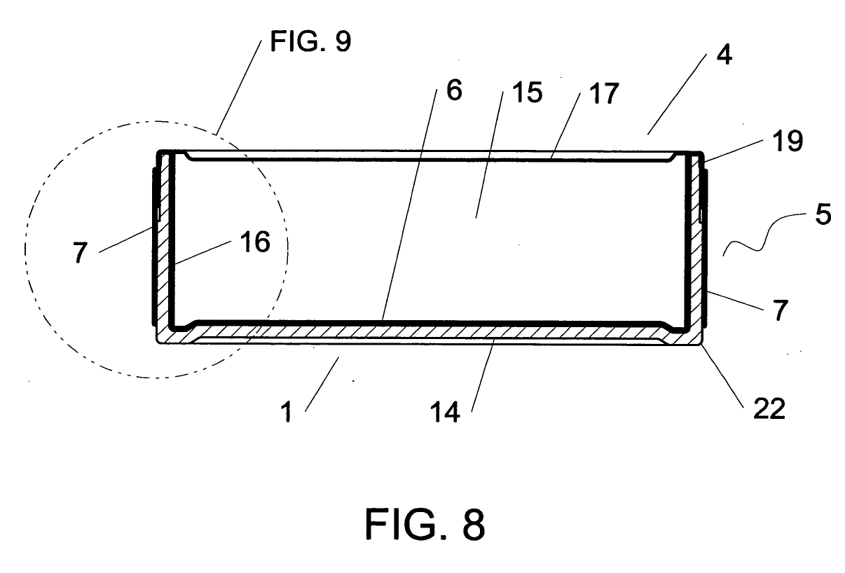

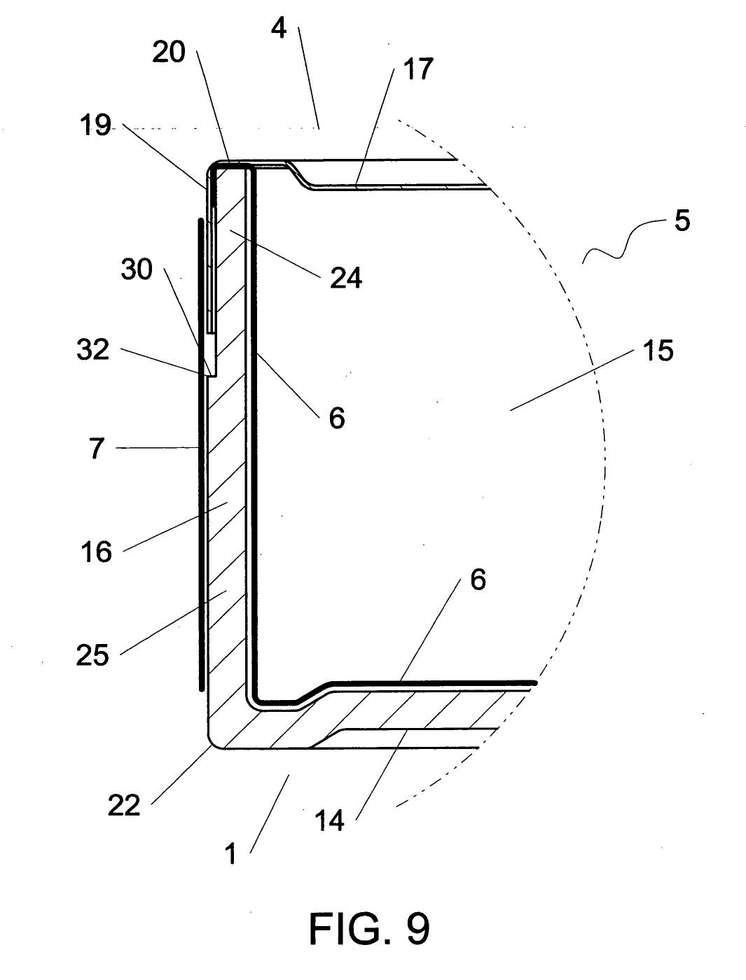

As illustrated in FIGS. 8-9, the container 5 may also include a label 7. If used, the label is preferably applied to the container 5 after the lid 4 is inserted onto the container body 1. Therefore, the label may be applied both to the outside surface of the side wall 16 of the body portion 25 of the container body 1 and also to the outside surface 26 of the side wall 19 of the lid 4. In this manner, the label 7 may be used to secure or seal the lid 4 to the container body 1. Preferably the label 7 is a generally rectangular-shaped label that can be applied to the container body side wall 16 and lid side wall 19 without creases, wrinkles, bends, or the like. As previously described, the label 7 can be applied without the creases, wrinkles, bends, or the like because the container body side wall 16 is non-drafted.

The container body 1 is preferably sized and shaped as a traditional smokeless tobacco container body, but other sizes or shapes can be utilized as desired for other uses. The container body 1 is most preferably a cylindrical body having a diameter of about 2.0 to about 3.0 inches, preferably, about 2.5 inches and a height of about 0.5 to about 1.5 inches, preferably, about ¾ inches. However, other sizes may also be suitable. In use, cavity 15 is preferably sized to receive a quantity of smokeless tobacco; however other materials may also be received in the container body 1.

A method of manufacturing the container body 1 will now be discussed. In general, the container body 1 is molded or otherwise formed from fibers, like cellulose or pulp slurry, and a plurality of molding or forming steps. It is preferred that the container body 1 is formed in a three-step cavity molding or forming process. The method of fabricating the container body 1 will now be described.

To form the container body 1 using the three-step process, preferably, three molding stages are completed using a first-cavity mold, a second-cavity mold, and a final-cavity mold. Each subsequent molding stage completes further container shaping and further water evacuation. In addition, the draft of each subsequent mold preferably decreases, where the final-cavity mold is, most preferably, a non-drafted mold. Each molding stage will now be described further.

The first-cavity mold is a female mold or cavity that is positively drafted and in the shape of the outside surface of the container body 1. The first-cavity mold includes a bottom wall and a side wall to form the mold cavity. The inside walls of the first-cavity mold are preferably lined with a porous material, such as a screen, mesh or the like, in the shape of the outside of the container body 1. In this first stage, the mold is positively drafted; that is, the mold cavity is tapered outwardly. The first-cavity mold has a draft of about 0.5° to about 2.5° and, preferably, about 1.5°. At this stage, any deposited fibers in the mold are moist and, therefore, a positive draft is preferred in order to aid the release of the fibers from the mold.

In the first-molding stage, the first-cavity mold is inserted or submerged into the slurry tank for a predetermined duration to load the cavity with the cellulose fibers. Preferably, the slurry tank includes an aqueous solution of about 0.1 weight percent to about 3 weight percent fibers. Once inserted in the slurry, to aid fiber loading, a vacuum may also be drawn on the first-cavity mold to help pull the cellulose fibers from the slurry tank and deposit such fibers into the mold. Once the fibers are deposited, the first-cavity mold forms an initial container body shape, which confirms to the shape of the container body 1, but may have a greater side portion draft or height than a finished container body 1.

Once the first-cavity mold is removed from the slurry, a transfer core is inserted into the first-cavity mold. The transfer core is a male mold that conforms to the shape of the inside surface of the container body 1. As opposed to the porous material lining the first-cavity mold, the transfer core preferably has a smooth surface. In use, the transfer core has multiple functions. One function is to apply pressure to the deposited fibers in each of the cavity molds, and another function is to transfer the formed container body shapes in each mold to the other cavity molds. The transfer core may also provide other functions as needed. After the pressing is completed in the first-cavity mold, the container body has a thickness of about 0.095 to about 0.079 inches.

After the compression and moisture removal in the first-cavity mold, the transfer core then moves or transfers the initial container body shape to the other cavity molds. In the three-step embodiment, the transfer core moves the initial container body shape to the second-cavity mold for continued shaping and water evacuation prior to the final shaping. To aid in the release of the initial container body shape from the first-cavity mold onto the transfer core, a small burst of air may be employed through the mesh screen to help provide positive release of the initial container body shape from the first-cavity mold; however, any method known in the art to transfer a molded shape from a cavity to a core may be employed. The transfer core then inserts or places the initial container body shape into the second-cavity mold for further processing.

The second-cavity mold, which is also a female mold or cavity, continues the shaping and the water evacuation from the fibers. The second-cavity mold is similar to the first-cavity mold in many aspects. For instance, the second-cavity mold also has a bottom wall and a side wall to form a mold cavity, has a positive draft, and is preferably lined with the porous material. More specifically, the second-cavity mold and the porous material therein also conform to the general shape of the outside of the container body 1 and have a draft equal to or less than the draft of the first-cavity mold. The second cavity mold has a draft of about 0.5 to about 2.5° and, preferably, about 1.5°.

Once the initial container body shape is inserted into the second-cavity mold, shaping and water evacuation are continued through positive pressure, negative pressure, heat, or vacuum. More specifically, the transfer core may apply a positive pressure to further compress the initial container body shape to a thinner thickness. In addition, a negative pressure may also be applied to the initial container body shape by applying a pressing force on the second-cavity mold opposite the force of the transfer core. In one aspect, the heat may be applied at the same time as the positive or negative pressure; however, in other aspects, the heat, positive pressure, and negative pressure may also be applied in various combinations or stages. As with the processing in the first-cavity mold, the vacuum, at similar levels, may further be drawn to help aid the water evacuation.

The combination of the pressure and heat in the second-cavity mold further compresses the initial shape and evacuates more moisture. The pressing, vacuum, and heat in the second-cavity mold can also vary depending on the cellulose fiber type, the slurry mixture composition, and/or the amount of cellulose fiber deposited in the mold. After the pressing is completed in the second-cavity mold, the container body has a thickness of about 0.078 to about 0.069 inches.

After processing in the second-cavity mold, the transfer core then moves or transfers the initial container body shape to the final- or third-cavity mold. As with the transfer from the first-cavity mold, a small burst of air may be employed through the mesh screen to help provide positive release of the initial container body shape from the second cavity mold; however, any method known in the art to transfer a molded shape from a cavity to a core may be employed at this stage as well. The transfer core then inserts or places the initial container body shape into the final-cavity mold for final processing.

The final-cavity mold is also similar to the previous molds in many aspects. For instance, the final-cavity mold is also a female mold or cavity having a bottom wall and a side wall to define a mold cavity; however, the final-cavity mold preferably has less draft than the other molds and, most preferably, is non-drafted. As with the other cavity molds, the final-cavity mold may be lined with the porous material. The final-cavity mold and the porous material are also in the general shape of the outside of the container body 1.

As indicated above, the final-cavity mold is preferably non-drafted. That is, the final-cavity mold side walls are perpendicular to the final-cavity mold bottom wall. Preferably, the final-cavity mold has about 0° of draft. In this non-drafted configuration, to aid in the removal of the container, the porous liner material in the final-cavity mold may further include a release coating. The release coating may be a Teflon or similar release-type coating.

The final shaping and water evacuation is completed in the final-cavity mold. Similar to the other stages, pressure and vacuum may be used to compress and evacuate moisture. As with the other molds, the pressure and vacuum can be simultaneous or sequential. The pressing and vacuum in the final-cavity mold can also vary depending on the desired thickness, the cellulose fiber type, the slurry mixture composition, and/or the amount of cellulose fiber deposited in the mold.

After sufficient pressing and water evacuation, the cellulose container body 1 is formed. After the pressing is completed in the final-cavity mold, the final container body has a thickness of about 0.068 to about 0.055 inches. At this point, the cellulose container body 1 is removed from the final-cavity mold and ready for post-molding operations, such as trimming, forming the lid recess 24 or sleeve, waxing, filling, liding, or labeling.

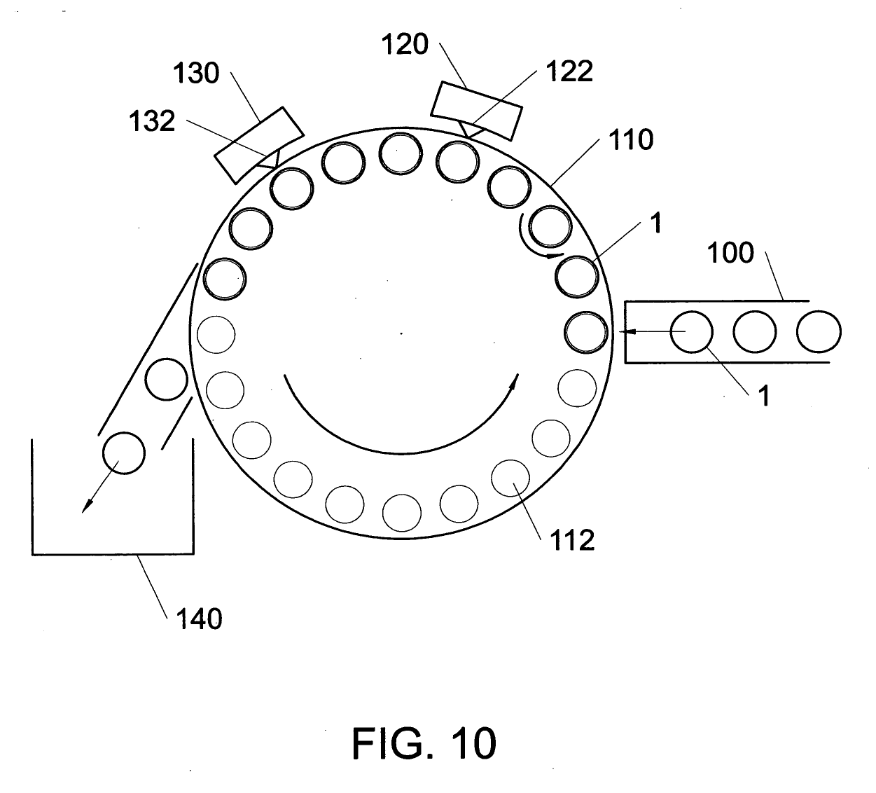

The height of the container body side wall 16 and lid recess 24 are preferably formed using a rotating mandrel 110 as illustrated in FIG. 10. For example, the container body 1 is transported to a cutting and lid recess forming operation through a conveyer belt or other suitable transportation device 100. The container body 1 is then transferred from the transportation device 100 to the rotating mandrel 110, which may have recesses or other securing structures 112 to hold the container body 1 along a periphery of the mandrel 110. To cut the container body 1 to the desired height, the mandrel 110 first rotates to a receiving position to accept the container body 1 from the transportation device 100. Next, the mandrel 110 rotates further to a cutting position where the container body 1 engages a first cutting operation 120. At the first cutting operation, the sidewall 16 height is trimmed to the desired height. Preferably, the container body 1 rotates within the mandrel 110 and engages a cutting knife 122 at the first cutting operation 120 to remove the undesired portion of the sidewall 16. Prior to the first cutting operation, the sidewall height is about 0.99 inches high. The first cutting operation 120 preferably removes about 0.06 inches so that the final height of the container is about 0.93 inches high.

After trimming, the mandrel 110 rotates further to a second cutting position where the container body 1 engages a second cutting operation 130. At the second cutting operation 130 the lid recess 24 is formed. Preferably, the container body 1 again rotates within the mandrel 110 and engages a lathe or other cutting knife 132 to trim, shave, or file off the desired thickness of the sidewall 16 to form the lid recess 24. As previously described, the second cutting operation 130 removes about 0.03 to about 0.01 inches of the sidewall 16 to form the lid recess 24. After the second cutting operation 130, the mandrel 110 rotates further to an ejection position and the container body 1 is ejected from the mandrel 110 to a receiving station 140 for optional further process, as mentioned above.

As discussed with each cavity mold, the molds preferably include a porous liner material. Such material is preferably a mesh, screen, sieve or the like, and also in the shape of the outside of the container body 1. Therefore, the porous material also has a bottom wall and a side wall that includes the appropriate draft as indicated in the discussion on each cavity mold. One method to form such container-shaped, porous liner is to spot weld a disk of the porous material to an annular ring of the porous material at an intersection point of the ring and the disk. However, spot welding may create imperfections in the liner material that forms undercuts, projections, or other rough edges that may hinder part ejection from the molds. For instance, the initial container body shape formed in the first-cavity mold may hang up on such undercuts or projections during part ejection. That is, the moist cellulose fibers may get caught on such imperfections and hold the cellulose in the mold. Accordingly, it is preferred that the liner material take on the outside shape of the container through a pressing or a drawing of a single sheet of the liner material into the desired shape. In this manner, a weld-free cavity liner is formed having substantially no undercuts, projections, rough edges, or other imperfections that may hinder the release of the container from each respective mold.

During the molding, the height of the container or the height of the side portion 16 is preferably formed higher than desired in the final container body 1. During the molding of cellulose, there is often a tendency for the cellulose fibers on vertical surfaces to slide or sink back into the mold, especially in the first-cavity mold where the cellulose has the greatest level of moisture. As a result, it is more difficult to hold the desired shape in the early stages. A common solution is to include an outwardly extending flange from the top edge of the container in the mold design. Such flange holds the cellulose in the vertical orientation in the mold and prevents the cellulose from sinking back into the mold. However, such traditional flanges complicate the trimming and formation of the lid recess 24 because the flange may interfere with the first and second cutting operations 120 and 130. Consequently, it is preferred that the molding steps be completed without the flange.

Instead of molding the container with the flange, the first-, second-, and final-cavity molds preferably have side walls that are higher than the desired height of the side portion 16 of the container body 1. After the three molding steps, the container may also be trimmed to a desired height prior to forming the lid recess depending on the degree of shrinkage of the side portion 16 during molding and the height of the side portion 16 desired.

As discussed previously with the container body 1, the lid recess 24 allows the side walls 19 of the lid 4 to fit flush with the outside of the body portion 25. The lid recess 24 is formed by compressing, trimming, filing, or shaving a top section of the container body 1 side portion 16 a predetermined amount.

After forming the lid recess, the container body 1 is transferred to other post forming operations, such as waxing, filling, liding, and labeling. Such operations are typical in the art and any common waxing, filing, liding, and labeling steps may be used with the above described method and container. As previously noted, it is preferred that the method fill the container body 1 with a quantity of chewing tobacco; however, other fillings may also be added.

It will be understood that various changes in the details, materials, and arrangements of parts and components, which have been herein described and illustrated in order to explain the nature of the invention, may be made by those skilled in the art within the principle and scope of the invention as expressed in the appended claims.

Advantages and embodiments of this invention are further illustrated by the following example, but the particular materials and amounts thereof recited in this example, as well as other conditions and details, should not be construed to unduly limit the invention. All percentages are by weight unless otherwise directed.

### EXAMPLE

This example provides a description of an exemplary fiber thermoforming operation used to form a fiber container body as described above. A molding machine was used to form the container body. The molding machine included a slurry tank, a vertically moveable platen for mounting a first cavity mold; a vertically and horizontally moveable platen for mounting a first transfer core; a stationary platen for mounting a second and third cavity mold; and a second vertically and horizontally moveable platen for mounting second and third transfer cores.

The slurry used to form the container body was prepared with about 99.3 percent ordinary tap water and about 0.7 percent cellulose pulp that was about 50 weight percent long, brown corrugate fiber and about 50 weight percent short, white paper fiber. The pulp fibers in the slurry tank were agitated and circulated for sufficient suspension. The slurry was maintained approximately at room temperature.

During pre-mold set-up, the stationary platen for the second and third mold cavities was heated to about 200° C. Likewise, the upper movable platens for the first, second, and third transfer cores were also heated to about 200° C.

At a first forming station, the first cavity mold was used to form a first container body. The first cavity mold was a female mold having the general shape of the outside of the container body and the first transfer core was a male mold having the general shape of the inside of the container body. Both the first cavity mold and transfer core were constructed out of machined aluminum. The first cavity mold had a draft angle of about 1.5° and was lined with a fine mesh stainless steel screen. The first transfer core had a draft angle of about 1.5° and was Teflon coated.

The formation of the first container body at the first forming station was as follows. The first cavity mold was submerged into the tank of slurry and a vacuum was used to pull or draw the slurry fibers into the first cavity mold and deposited onto the screen. The first cavity mold was submerged in the tank about 10 seconds. The first cavity mold was then removed from the tank and the first transfer core was inserted into the first cavity mold to perform a first pressing operation. The first cavity mold and the first transfer core were pressed together for about 2 minutes so that the initial container body shape had a wall thickness of about 0.08 inches. During this forming step, the container body was molded about 0.125 inches taller than required in anticipation of some sidewall compression that may take place during subsequent processing. The first container body shape has a diameter of about 2.5 inches. Because the platens were heated, about 50 percent of the moisture in the compressed fibers was removed at this station.

Next, the first container body was transferred to a second forming station. The first transfer core was used to move the container body between the first and second forming stations. The first transfer core was retracted and moved away from the first molding cavity and at the same time a positive air pressure was applied to the first cavity mold and a negative pressure was applied to the first transfer core to release the first container body shape from the first cavity mold. The platen holding the first transfer core was then moved horizontally and positioned over and into the second cavity mold. At this point, a positive air pressure was applied to the first transfer core and a negative pressure was applied to the second cavity mold to place the first container body in the second cavity mold.

The second cavity mold, which was also constructed out of machined aluminum, also had a draft angle of about 1.5° and was Teflon coated. In this example, the second cavity mold did not include the stainless steel mesh screen; however, as previously described, the second cavity mold may also include the screen. At the second forming station, a second transfer core was used. The second transfer core had a draft angle of about 1.5°, was also constructed out of machined aluminum, and was also coated with Teflon.

At the second forming station, the second transfer core completed a second pressing operation to form a second container body. The second transfer core was inserted into the second cavity mold for the second pressing operation for about 1.75 minutes. During this second pressing, the heated platen resulted in about 50 percent of the remaining moisture from the container body being removed. After the second pressing, the second container body had a wall thickness of about 0.07 inches.

The second container body was then transferred to a third forming station. The transfer of the second container body was similar to the transfer of the first container body. At the third forming station, a third cavity mold and a third transfer core was used. The third cavity mold was also formed from machined aluminum, had a draft angle of about 0°, and was coated with Teflon. Similar to the second cavity mold, the third cavity mold could also have the mesh screen, but did not in this example. The third transfer core was also formed from machined aluminum, had a draft angle of 0°, and coated with Teflon. Similar to the other forming operations, the third transfer core was inserted into the third cavity mold for a third and final pressing for about 1.5 minutes to form the final container body. During this final pressing, about 50 percent of the remaining moisture was removed from the final container body.

After the final forming station and final pressing, the final container body had a wall thickness of about 0.06 inches and had an overall height of about 0.99 inches, which was about 0.06 inches taller than desired. Accordingly, the final container body was cut down to a final height of about 0.93 inches.

What is claimed is:

1. A container body comprising:
a single fiber structure molded into the container body having an integral bottom portion and an integral side portion;
an open cavity defined by the bottom portion and the side portion; and
the side portion being perpendicular to the bottom portion such that a rectangular label is mountable to the side portion without creases.

2. The container body of claim 1, wherein the side portion is tapered outwardly between about 0° and about 2°.

3. The container body of claim 2, wherein the side portion is tapered outwardly from perpendicular about 0°.

4. The container body of claim 1, wherein the side portion further comprises a lower side portion extending upwardly from the bottom portion, a upper side portion recessed inwardly from the lower side portion, and a shoulder portion interposed between and joining the lower side portion to the upper side portion, wherein the upper side portion is for receiving a lid.

5. The container body of claim 4, wherein the upper side portion is recessed between 0.006 and 0.01 inches.

6. The container body of claim 1, wherein the fiber structure contains compressed pulp fibers.

7. The container body of claim 1, wherein the fiber structure contains at least one of the following corrugate, brown paper, clipboard, recycling paper, copy paper, printer paper, polymer fibers, and cotton fibers.

8. A container comprising the container body of claim 1 and a container lid.

9. A container comprising the container body of claim 4 and a container lid.

10. A method for preparing a non-drafted container body comprising:
drawing fibers into a first-cavity mold;
forming the fibers into an initial container body shape within the first-cavity mold;
transferring the initial container body shape to at least one further-cavity mold; and
forming the initial container body shape into the container body within the at least one further-cavity mold; and
the at least one further-cavity mold having a draft angle less than or equal to the draft angle of the first-cavity mold.

11. The method of claim 10, comprising a first, a second and a third cavity mold.

12. The method of claim 11, wherein the first cavity mold has a draft of about 0.5° to about 2.5°.

13. The method of claim 11, wherein the second cavity mold has a draft of about 0.5° to about 2.5°.

14. The method of claim 11, wherein the third cavity mold has a draft of about 0.0°.

15. The method of claim 11, wherein the first cavity mold produces a body shape with a wall thickness of about 0.095 to about 0.079 inches.

16. The method of claim 11, wherein the second cavity mold produces a body shape with a wall thickness of about 0.078 to about 0.069 inches.

17. The method of claim 11, wherein the second cavity mold produces a body shape with a wall thickness of about 0.068 to about 0.055 inches.

18. The method of claim 11, wherein each of the cavity molds comprises a weld-free porous liner.

19. The method of claim 10, further comprising forming a lid recess on the container body side portion.

20. The method of claim 10, wherein the fibers are drawn from a cellulose slurry that comprises about 0.1 to about 1.0 percent cellulose fiber.
